(19) United States
(12) Patent Application Publication
(10) Pub. No.: US 2017/0123525 A1
(43) Pub. Date: May 4, 2017

(54) SYSTEM AND METHOD FOR GENERATING RELIABLE ELECTRICAL CONNECTIONS

(71) Applicant: Synaptics Incorporated, San Jose, CA (US)

(72) Inventors: Tzeng-Fu Kao, Taipei (TW); Chris Rehn, Taipei (TW)

(21) Appl. No.: 15/052,304

(22) Filed: Feb. 24, 2016

Related U.S. Application Data
(60) Provisional application No. 62/248,100, filed on Oct. 29, 2015.

(51) Int. Cl. G06F 3/041

(52) U.S. Cl. CPC G06F 3/041; G06F 2203/04108; G06F 2203/04103

(57) ABSTRACT

An input device may include a sensor substrate that including various sensor electrodes. The sensor electrodes may detect a location of one or more input objects. The input device may include a contact area coupled with the sensor substrate. The contact area may include a protective coating residue and a solder element array disposed on the contact area. The input device may include an electrical ground ohmically coupled to the contact area through the solder element array.

### CROSS-REFERENCE TO RELATED APPLICATIONS

This application claims priority to U.S. Provisional Patent Application Ser. No. 62/248,100, which was filed on Oct. 29, 2015, and is incorporated herein by reference.

### FIELD

This invention generally relates to electronic devices.

### BACKGROUND

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY

In general, in one aspect, the invention relates to a method of manufacturing. The method includes obtaining a contact area covered in a protective coating that prevents oxidation of the contact area. The contact area is coupled to a sensor substrate that includes various sensor electrodes. The sensor electrodes detect a location of one or more input objects. The method further includes depositing a solder paste array on the contact area. The method further includes removing a portion of the protective coating from the contact area. The method further includes coupling the contact area to a bracket component.

In general, in one aspect, the invention relates to an input device. The input device includes a sensor substrate that includes various sensor electrodes. The sensor electrodes detect a location of one or more input objects. The input device further includes a contact area coupled with the sensor substrate. The contact area includes a protective coating residue and a solder element array disposed on the contact area. The input device further includes an electrical ground ohmically coupled to the contact area through the solder element array.

In general, in one aspect, the invention relates to an electronic system. The electronic system includes a display device and an input device coupled to the display device. The input device includes a sensor substrate including various sensor electrodes. The sensor electrodes detect a location of one or more input objects. The input device further includes a contact area coupled with the sensor substrate. The contact area includes a protective coating residue and a solder element array disposed on the contact area. The input device further includes an electrical ground ohmically coupled to the contact area through the solder element array.

Other aspects of the invention will be apparent from the following description and the appended claims.

### BRIEF DESCRIPTION OF DRAWINGS

FIG. 1 shows a block diagram in accordance with one or more embodiments.

FIGS. 2, 3.1, 3.2, and 4 show schematic diagrams in accordance with one or more embodiments.

FIG. 5 shows a flowchart in accordance with one or more embodiments.

FIGS. 6.1 and 6.2 show a computing system in accordance with one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments provide input devices and methods that facilitate improved usability. In particular, one or more embodiments are directed to a method of manufacturing a contact area with an ohmic connection to a bracket in an input device. Specifically, the contact area may have a protective coating, such as an organic solderability preservative (OSP) coating, that prevents oxidation of the contact area. However, in assembling the input device, a resulting connection between the contact area and the bracket may have an unreliable impedance value due to, for example, protective coating residue and/or leftover flux from solder paste. Accordingly, in one or more embodiments, the contact area is bonded to the bracket using a solder element array produced from solder paste. After the removal of the protective coating through a heating process, for example, the resulting solder from the solder paste array may produce an array of solder elements with increased conductivity between the contact area and the bracket. Furthermore, by coupling the bracket to an electrical ground within an input device, the contact area may produce a reliable ground pad that prevents electrostatic discharge failure within the input device.

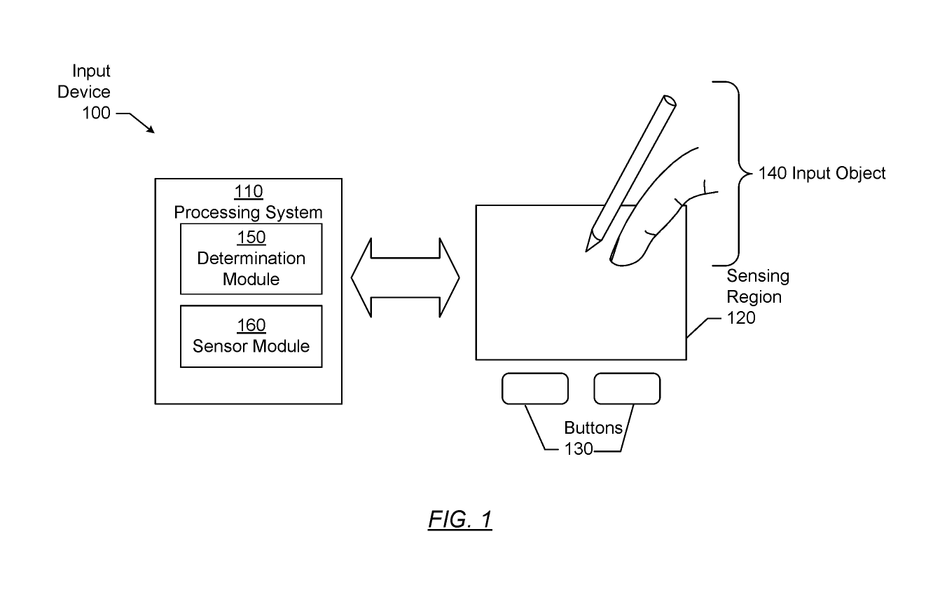

Turning now to the figures, FIG. 1 is a block diagram of an exemplary input device (100), in accordance with embodiments of the invention. The input device (100) may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device (100) and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device (100) may be implemented as a physical part of the electronic system, or may be physically separate from the electronic system. Further, portions of the input device (100) as part of the electronic system. For example, all or part of the determination module may be implemented in the device driver of the electronic system. As appropriate, the input device (100) may communicate with parts of the electronic system using any one or more of the following: buses, networks, and other wired or wireless interconnections. Examples include I2C, SPI, PS/2, Universal Serial Bus (USB), Bluetooth, RF, and IRDA.

In FIG. 1, the input device (100) is shown as a proximity sensor device (also often referred to as a “touchpad” or a “touch sensor device”) configured to sense input provided by one or more input objects (140) in a sensing region (120). Example input objects include fingers and styli, as shown in FIG. 1. Throughout the specification, the singular form of input object is used. Although the singular form is used, multiple input objects exist in the sensing region (120). Further, which particular input objects are in the sensing region may change over the course of one or more gestures. For example, a first input object may be in the sensing region to perform the first gesture, subsequently, the first input object and a second input object may be in the above surface sensing region, and, finally, a third input object may perform the second gesture. To avoid unnecessarily complicating the description, the singular form of input object is used and refers to all of the above variations.

The sensing region (120) encompasses any space above, around, in and/or near the input device (100) in which the input device (100) is able to detect user input (e.g., user input provided by one or more input objects (140)). The sizes, shapes, and locations of particular sensing regions may vary widely from embodiment to embodiment.

In some embodiments, the sensing region (120) extends from a surface of the input device (100) in one or more directions into space until signal-to-noise ratios prevent sufficiently accurate object detection. The extension above the surface of the input device may be referred to as the above surface sensing region. The distance to which this sensing region (120) extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device (100), contact with an input surface (e.g. a touch surface) of the input device (100), contact with an input surface of the input device (100) coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region (120) has a rectangular shape when projected onto an input surface of the input device (100).

The input device (100) may utilize any combination of sensor components and sensing technologies to detect user input in the sensing region (120). The input device (100) includes one or more sensing elements for detecting user input. As several non-limiting examples, the input device (100) may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes. Further, some implementations may be configured to provide a combination of one or more images and one or more projections.

In some resistive implementations of the input device (100), a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device (100), one or more sensing elements pick up loop currents induced by a resonating coil or pair of coils. Some combination of the magnitude, phase, and frequency of the currents may then be used to determine positional information.

In some capacitive implementations of the input device (100), voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may by a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “trans capacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals (also called “sensing signal”). Receiver sensor electrodes may be held substantially constant relative to the reference voltage to facilitate receipt of resulting signals. The reference voltage may by a substantially constant voltage and in various embodiments; the reference voltage may be system ground. In some embodiments, transmitter sensor electrodes may both be modulated. The transmitter electrodes are modulated relative to the receiver electrodes to transmit transmitter signals and to facilitate receipt of resulting signals. A resulting signal may include effect(s) corresponding to one or more transmitter signals, and/or to one or more sources of environmental interference (e.g. other electromagnetic signals). The effect(s) may be the transmitter signal, a change in the transmitter signal caused by one or more input objects and/or environmental interference, or other such effects. Sensor electrodes may be dedicated transmitters or receivers, or may be configured to both transmit and receive. Measurements acquired using mutual capacitance sensing methods may be referred to as mutual capacitance measurements.

Further, the sensor electrodes may be of varying shapes and/or sizes. The same shapes and/or sizes of sensor electrodes may or may not be in the same groups. For example, in some embodiments, receiver electrodes may be of the same shapes and/or sizes while, in other embodiments, receiver electrodes may be varying shapes and/or sizes.

In FIG. 1, a processing system (110) is shown as part of the input device (100). The processing system (110) is configured to operate the hardware of the input device (100) to detect input in the sensing region (120). The processing system (110) includes parts of or all of one or more integrated circuits (ICs) and/or other circuitry components. For example, a processing system for a mutual capacitance sensor device may include transmitter circuitry configured to transmit signals with transmitter sensor electrodes, and/or receiver circuitry configured to receive signals with receiver sensor electrodes. Further, a processing system for an absolute capacitance sensor device may include driver circuitry configured to drive absolute capacitance signals onto sensor electrodes, and/or receiver circuitry configured to receive signals with those sensor electrodes. In one more embodiments, a processing system for a combined mutual and absolute capacitance sensor device may include any combination of the above described mutual and absolute capacitance circuitry. In some embodiments, the processing system (110) also includes electronically-readable instructions, such as firmware code, software code, and/or the like. In some embodiments, components composing the processing system (110) are located together, such as near sensing element(s) of the input device (100). In other embodiments, components of processing system (110) are physically separate with one or more components being close to the sensing element(s) of the input device (100), and one or more components being located elsewhere. For example, the input device (100) may be a peripheral coupled to a computing device, and the processing system (110) may include software configured to run on a central processing unit of the computing device and one or more ICs (perhaps with associated firmware) separate from the central processing unit. As another example, the input device (100) may be physically integrated in a mobile device, and the processing system (110) may include circuits and firmware that are part of a main processor of the mobile device. In some embodiments, the processing system (110) is dedicated to implementing the input device (100). In other embodiments, the processing system (110) also performs other functions, such as operating display screens, driving haptic actuators, etc.

The processing system (110) may be implemented as a set of modules that handle different functions of the processing system (110). Each module may include circuitry that is a part of the processing system (110), firmware, software, or a combination thereof. In various embodiments, different combinations of modules may be used. For example, as shown in FIG. 1, the processing system (110) may include a determination module (150) and a sensor module (160). The determination module (150) may include functionality to determine when at least one input object is in a sensing region, determine signal to noise ratio, determine positional information of an input object, identify a gesture, determine an action to perform based on the gesture, a combination of gestures or other information, and/or perform other operations.

The sensor module (160) may include functionality to drive the sensing elements to transmit transmitter signals and receive the resulting signals. For example, the sensor module (160) may include sensory circuitry that is coupled to the sensing elements. The sensor module (160) may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals.

Although FIG. 1 shows a determination module (150) and a sensor module (160), alternative or additional modules may exist in accordance with one or more embodiments of the invention. Such alternative or additional modules may correspond to distinct modules or sub-modules than one or more of the modules discussed above. Example alternative or additional modules include hardware operation modules for operating hardware such as sensor electrodes and display screens, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system (110) responds to user input (or lack of user input) in the sensing region (120) directly by causing one or more actions. Example actions include changing operation modes, as well as graphical user interface (GUI) actions such as cursor movement, selection, menu navigation, and other functions. In some embodiments, the processing system (110) provides information about the input (or lack of input) to some part of the electronic system (e.g. to a central processing system of the electronic system that is separate from the processing system (110), if such a separate central processing system exists). In some embodiments, some part of the electronic system processes information received from the processing system (110) to act on user input, such as to facilitate a full range of actions, including mode changing actions and GUI actions.

For example, in some embodiments, the processing system (110) operates the sensing element(s) of the input device (100) to produce electrical signals indicative of input (or lack of input) in the sensing region (120). The processing system (110) may perform any appropriate amount of processing on the electrical signals in producing the information provided to the electronic system. For example, the processing system (110) may digitize analog electrical signals obtained from the sensor electrodes. As another example, the processing system (110) may perform filtering or other signal conditioning. As yet another example, the processing system (110) may subtract or otherwise account for a baseline, such that the information reflects a difference between the electrical signals and the baseline. As yet further examples, the processing system (110) may determine positional information, determine force information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

“Force information” as used herein is intended to broadly encompass force information regardless of format. For example, the force information may be provided for each object as a vector or scalar quantity. As another example, the force information may be provided as an indication that determined force has or has not crossed a threshold amount. As other examples, the force information can also include time history components used for gesture recognition. As will be described in greater detail below, positional information and force information from the processing systems may be used to facilitate a full range of interface inputs, including use of the proximity sensor device as a pointing device for selection, cursor control, scrolling, and other functions.

In some embodiments, the input device (100) is implemented with additional input components that are operated by the processing system (110) or by some other processing system. These additional input components may provide redundant functionality for input in the sensing region (120), or some other functionality. FIG. 1 shows buttons (130) near the sensing region (120) that may be used to facilitate selection of items using the input device (100). Other types of additional input components include sliders, balls, wheels, switches, and the like. Conversely, in some embodiments, the input device (100) may be implemented with no other input components.

In some embodiments, the input device (100) includes a touch screen interface, and the sensing region (120) overlaps at least part of an active area of a display screen. For example, the input device (100) may include substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device (100) and the display screen may share physical elements. For example, some embodiments may utilize some of the same electrical components for displaying and sensing. In various embodiments, one or more display electrodes of a display device may configured for both display updating and input sensing. As another example, the display screen may be operated in part or in total by the processing system (110).

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media that is readable by the processing system (110)). Additionally, the embodiments of the present invention apply equally regardless of the particular type of medium used to carry out the distribution. For example, software instructions in the form of computer readable program code to perform embodiments of the invention may be stored, in whole or in part, temporarily or permanently, on a non-transitory computer readable storage medium. Examples of non-transitory, electronically readable media include various discs, physical memory, memory, memory sticks, memory cards, memory modules, and or any other computer readable storage medium. Electronically readable media may be based on flash, optical, magnetic, holographic, or any other storage technology.

Although not shown in FIG. 1, the processing system (110), the input device (100), and/or the host system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores, or micro-cores of a processor. Further, one or more elements of one or more embodiments may be located at a remote location and connected to the other elements over a network. Further, embodiments of the invention may be implemented on a distributed system having several nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While FIG. 1 shows a configuration of components, other configurations may be used without departing from the scope of the invention. For example, various components may be combined to create a single component. As another example, the functionality performed by a single component may be performed by two or more components.

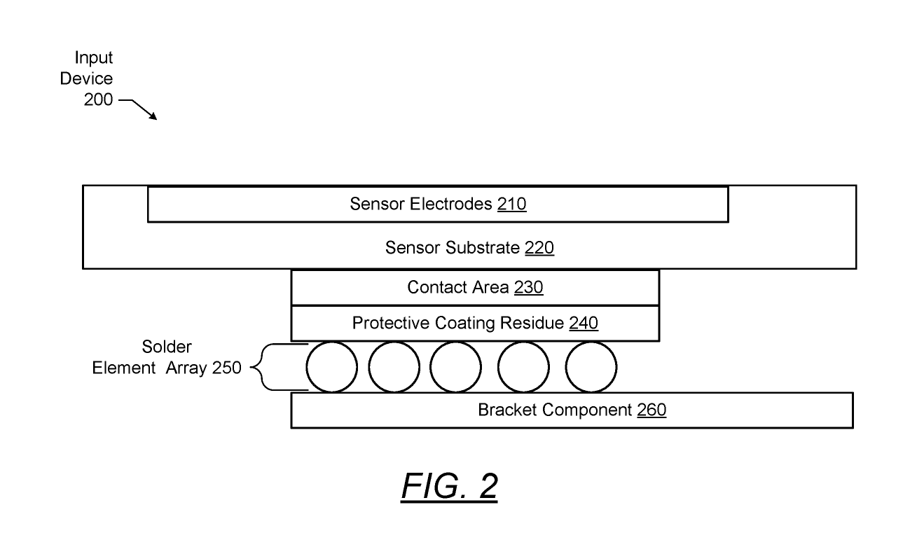

Turning to FIG. 2, FIG. 2 shows a schematic diagram in accordance with one or more embodiments. As shown in FIG. 2, an input device (200) includes various sensor electrodes (210) disposed on a sensor substrate (220). The sensor electrodes (210) may be sensor electrodes similar to the sensor electrodes described in FIG. 1 and the accompanying description. For example, the sensor electrodes may include proximity sensors that include functionality to detect the location of one or more input objects in a sensing region. Moreover, the sensor electrodes (210) may be ohmically connected to solder points on the opposite side of the sensor substrate (220) using interlayer vias through the sensor substrate (220). The sensor electrodes may also be force sensor electrodes that include functionality to detect an input force applied by an input object to an input surface (not shown). Moreover, the sensor substrate (220) may be a physical layer, such as a wafer, that is used in fabricating a semiconductor device. For example, the sensor substrate (220) may be a printed circuit board. For more information on the sensor substrate (220), see FIG. 4 and the accompanying description below.

The sensor substrate (220) may be operably connected to a contact area (230). The contact area (230) may include functionality to provide one or more ohmic connections between one or more integrated circuits (not shown) in the sensor substrate (220) and a portion of a bracket (e.g., bracket component (260)). For example, the contact area (230) may be a metallic area in the sensor substrate (220) that includes functionality to act as a ground pad for multiple integrated circuits coupled to the sensor substrate (220). Accordingly, the contact area (230) may be made from copper or another conductive material.

Keeping with FIG. 2, in one or more embodiments, a protective coating residue (240) is a resulting product of a protective coating previously disposed on the contact area (230) during the manufacturing of the input device (200). In one or more embodiments, for example, the protective coating residue (240) is a portion of the protective coating that is not removed during reflow or another removal process.

In one or more embodiments, for example, a protective coating applied to the contact area (230) includes functionality to prevent one or more chemical reactions occurring to the contact area (230) before the sensor substrate (220) undergoes a surface mounting technology (SMT) process. In other words, without the use of a protective coating, a portion of the contact area (230) may oxidize as a result of various manufacturing processes performed in assembling the input device (200). Rather than using an expensive inert metal such as gold for the contact area (230), for example, the protective coating may isolate the contact area (230) from oxidation for a desired period of time. In one or more embodiments, the protective coating includes an organic solderability preservative (OSP) compound. Accordingly, the protective coating may include a chemical compound from the azole class of water-based compounds for producing protective coatings on substrates.

In one or more embodiments, a solder element array (250) is disposed on the contact area (230). In one or more embodiments, for example, the solder element array (250) is a result of a solder paste array applied during the manufacturing of the input device (200). Specifically, solder paste may be a mixture of solder and flux. The flux may be, for example, a rosin-based flux, a water-soluble flux, and/or a no-clean flux. While the solder element array (250) is shown in FIG. 2 as including a series of approximately round uniform masses, in other embodiments, the solder element array (250) may include other shapes. In one or more embodiments, for example, a solder paste array may be deposited on the contact area (230) in various polygonal-shaped masses to produce the solder element array (250). For example, solder elements in the solder element array (250) may be individual masses that correspond to triangles, squares, hexagons, etc., as well as any other geometric shapes. Furthermore, elements of the solder element array (250) may include approximately uniform-sized masses and/or elements of different sizes.

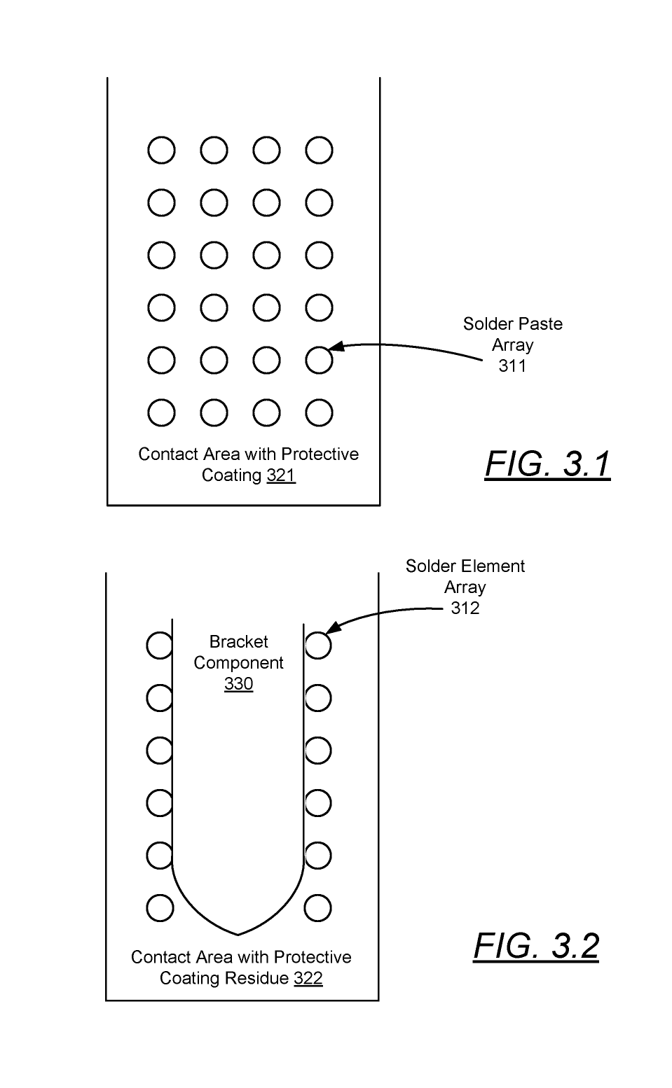

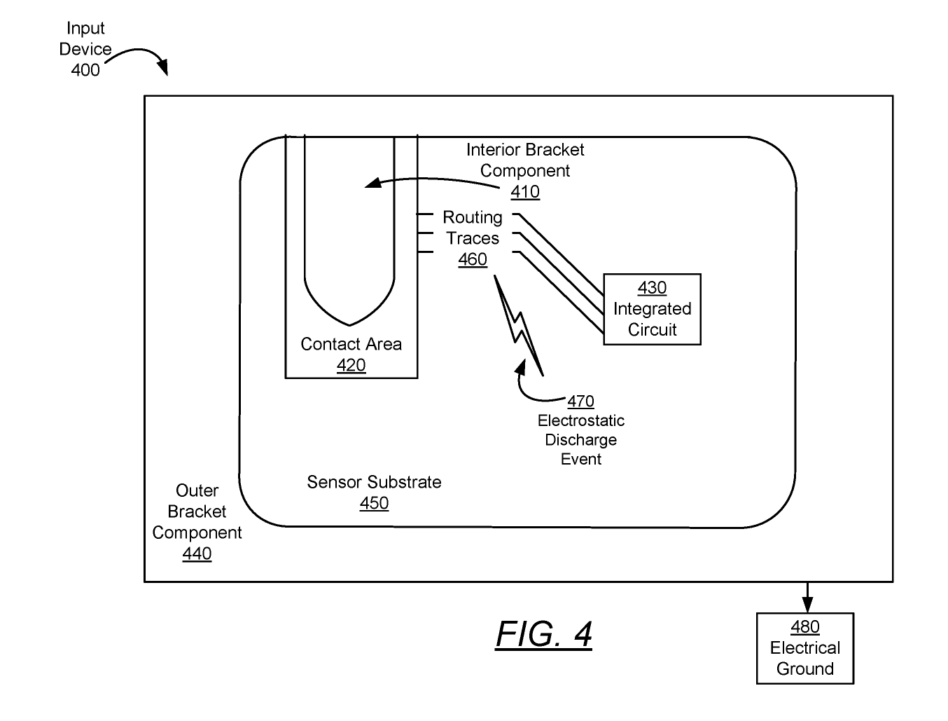

Turning to FIGS. 3.1-3.2, FIGS. 3.1-3.2 show schematic diagrams in accordance with one or more embodiments. As shown in FIGS. 3.1-3.2, a contact area (321) with a protective coating may have a solder paste array (311) deposited in the contact area (321). In FIG. 3.2, a bracket component (330) is bonded to a contact area (322) with protecting coating residue from a manufacturing process. For example, the bracket component (330) may be connected to the contact area using a solder element array (312). In particular, the solder element array (312) may be the product of the solder paste array (311) after a heating process, such as a reflow process. For example, a heating process may transform the solder paste array (311) into a series of solder elements (e.g., the solder element array (312)) between the contact area (322) and the interior bracket component (330). In other words, by melting the solder paste array (311), flux may evaporate, and leave the solder element array (312) bonded with the contact area (321) and the interior bracket component (330).

Turning to FIG. 4, FIG. 4 shows a schematic diagram in accordance with one or more embodiments. As shown in FIG. 4, an input device (400) may include a sensor substrate (450) and a contact area (420). The sensor substrate (450) and the contact area (420) may be similar to the sensor substrate and contact area described in FIG. 2 and the accompanying description. In one or more embodiments, the contact area (420) may be overlapped by an interior bracket component (410) that is bonded to the contact area with a solder element array similar to the one shown in FIG. 3.2. For example, the solder element array may be produced by sending the solder paste array described in FIG. 3.2 through one or more heating processes.

Furthermore, the input device (400) may include one or more integrated circuits (e.g., integrated circuit (430)) mounted to the sensor substrate (450). The integrated circuit (430) may be ohmically connected to the contact area (420) by various routing traces (e.g., routing traces (460)). The routing traces (460), for example, may be conductive traces deposited on the sensor substrate (450). For example, the routing traces (460) may be ground traces connected to one or more ground pins (not shown) of the integrated circuit (430).

Keeping with FIG. 4, an electrostatic discharge (ESD) event (470) may occur within the input device (400). In particular, the ESD event (470) may be an electrical pulse that impacts a portion of the input device (400), such as the integrated circuit (430). For example, the ESD event may generate a current, e.g., 1 Amp, over a short duration of time, e.g., 1 nanosecond to 100 nanoseconds. ESD events may be generated by positive or negative electric charges accumulating in the input device (400). Accordingly, during the ESD event (470), electrical current produced by the ESD event (470) may seek a discharge path of current to the electrical ground (480). Specifically, the electrical ground (480) may be a reference point for electrical potentials in the input device (400). Thus, electrical current in the input device (400) may seek a common return path back to electrical ground (480). Moreover, the electrical ground (480) may be a system ground or a chassis ground.

In order to produce the discharge path, the contact area (420) may be ohmically coupled to the electrical ground (480) via an interior bracket component (410). The interior bracket component (410) may be metallic and be similar to a “metal finger” in extending across the contact area (420). Accordingly, the interior bracket component (410) may be operably connected to an outer bracket component (440), which is operably connected to the electrical ground (480). In some embodiments, portions of a bracket (e.g., the interior bracket component (410), the outer bracket component (440)) provide deflection functionality within the input device (400) to produce a clickpad. A clickpad may include an activation element (e.g. a tact switch) communicatively coupled to the processing system and with functionality to determine user input based on a user triggering the activation element.

Additionally, the sensor substrate (450) may also include an electrostatic discharge protection mechanism (not shown). For example, the sensor substrate (450) may include a ring of conductive material that surrounds a sensor area (e.g., an area with sensor electrodes) in the sensor substrate (450). The ring of conductive material may produce a discharge path with a low impedance away from the sensor area. In other words, when the ESD event (470) occurs, a potentially destructive voltage may flow through the ring of conductive material (also called a “strike ring”) to the electrical ground (480), rather than through sensor electrodes disposed in the sensor substrate (450).

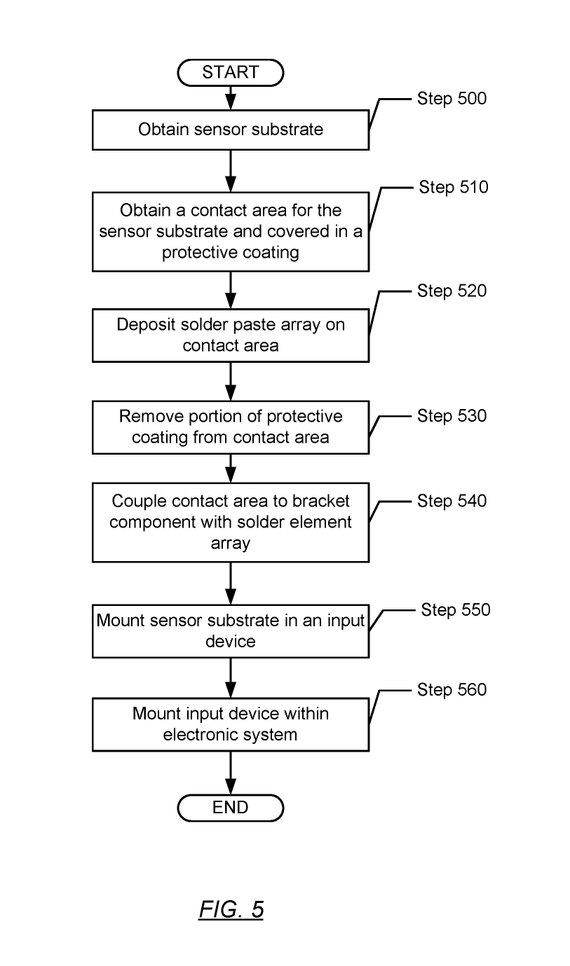

Turning to FIG. 5, FIG. 5 shows a flowchart in accordance with one or more embodiments. While the various steps in these flowcharts are presented and described sequentially, one of ordinary skill in the art will appreciate that some or all of the steps may be executed in different orders, may be combined or omitted, and some or all of the steps may be executed in parallel. Furthermore, the steps may be performed actively or passively.

In Step 500, a sensor substrate is obtained in accordance with one or more embodiments. For example, the sensor substrate may be the sensor substrate described in FIGS. 2 and/or 4 and the accompanying description.

In Step 510, a contact area covered in a protective coating is obtained for a sensor substrate in accordance with one or more embodiments. For example, a contact area made of copper may be formed using a heavy or light bath, which may be followed by copper electroplating of the contact area. Once the contact area is formed in the sensor substrate, a protective coating may be deposited on the contact area using an aqueous solution that bonds a protective coating material to the contact area. In one or more embodiments, for example, the protective coating is an organic solderability preservative (OSP) compound, such as a member of the azole class, such as a triazole compound, an imidazole compound, or benzimidazole compound. After application of the protective coating to the contact area, the sensor substrate may be rinsed to clean the aqueous solution from the sensor substrate.

In Step 520, a solder paste array is deposited on a contact area in accordance with one or more embodiments. In one or more embodiments, solder paste may be deposited on the contact area from Step 510 according to a specific design and/or specific pitch between various solder paste masses among the solder paste array. For example, the formation and/or geometry of a solder element array in an input device may be controlled during the deposition process in Step 520. Accordingly, the design of the solder paste size and/or geometry may be specified to achieve a desired formation and/or geometry of a solder element array for coupling a contact area with a bracket component in Step 540 below.

In one or more embodiments, for example, a solder paste array is deposited in a regular pattern such that during removal of the protective coating in Step 530 below, members of the solder paste array bond with the contact area of the sensor substrate from Step 500. Members of the solder paste array may be deposited, for example, according to a spacing from 0.5 mm to 1.5 mm between adjacent members of the solder paste array. In other words, members of solder paste may be separated within a contact area, for example, by a distance between 0.5 mm to 1.5 mm.

Moreover, the size of a deposited member of the solder paste array may have a diameter, for example, between 0.2 mm and 0.7 mm. However, other dimensions may be used for members of a solder paste array as well. The solder paste array may be deposited at approximately the same time as the solder paste is deposited onto the solder points in anticipation of soldering other electrical components to a side of the sensor substrate from Step 500.

In one or more embodiments, the solder paste array includes various solder balls. For example, a solder ball may have a diameter that is approximately 0.4 mm. Moreover, a solder paste array may have a 1.0 mm pitch separating a solder ball from adjacent solders balls among the solder paste array. Rather than approximately spherical in shape, the solder paste array may also include solder bumps. A solder bump may be similar to a hemisphere or other portion of a spherical shape.

In Step 530, a portion of a protective coating is removed from a contact area in accordance with one or more embodiments. During surface mounting of solder points and/or one or more integrated circuits to the sensor substrate from Step 500, the protective coating may sufficiently evaporate from heat, for example, during a reflow process. Moreover, evaporation of the protective coating may produce ohmic connections between sensor electrodes disposed in the sensor substrate. However, during this process the OSP layer may evaporate in the area of the ground pad thereby exposing the copper ground pad to oxidation. Additionally, if the OSP layer in the ground pad area does not sufficiently evaporate, the eventual connection to the metal bracket may be insufficiently conductive to provide the low impedance path necessary for ESD events. In one or more embodiments, in produce sufficient protection of a contact area, more protective coating material is applied in Step 510 than is removed in Step 530. Thus, protective material residue on the contact area may be guaranteed in Step 540 below.

During a reflow process, for example, the solder paste array may be heated to produce multiple solder elements, such as in a solder element array, that provide electrical and mechanical connections between the contact area and the bracket component. In particular, such a heating process may include a temperature range of 230°-265° Celsius. For example, 265° Celsius may correspond to a peak temperature in a lead-free reflow process. In one or more embodiments, the heating process is a reflow process. Specifically, the reflow process may include sending the sensor substrate with a solder paste array through a reflow oven or other thermal heating device. In one or more embodiments, the protective coating is removed in Step 530 before an integrated circuit is coupled to the sensor substrate from Step 500.

In Step 540, a contact area is coupled to a bracket component with a solder element array in accordance with one or more embodiments. In particular, a solder paste array may provide an adhesive connection between the contact area from Step 510 and a bracket component. The solder paste array may be transformed into a solder element array in Step 530. Thus, Step 530 and Step 540 may be combined into a single step in a manufacturing process.

In one or more embodiments, an oxidized copper layer forms at the surface of exposed copper in the contact area of Step 540, for example, if a protective coating material is completely removed by a reflow process and/or by additional cleaning. As such, this oxidized copper layer may have a high electric resistance. Thus, in one or more embodiments, a solder element array produces increased conductivity between the contact area and the bracket component to address the high electric resistance of the oxidized copper layer.

Moreover, a separate adhesive may be applied to various solder connections produced from the solder paste array from Step 520 to bond the bracket component to the contact area. In one or more embodiments, ohmically coupling the contact area to the bracket components provides an ohmic connection to an electrical ground for one or more components, such as an integrated circuit, coupled to the contact area on the same side of the sensor substrate. Specifically, an electrical ground pin of an integrated circuit may have an ohmic connection, through routing traces for example, to the contact area, which is grounded by a connection through to the bracket component. In one or more embodiments, moreover, coupling the contact area to the bracket interior component produces an electrical ground pin with the same electric potential as the bracket component.

In one or more embodiments, the solder element array produces an increased amount of conductivity between the contact area and the bracket. Accordingly, this increased conductivity may eliminate effects of protective coating residual and/or unevaporated flux remaining in solder elements produced in an input device. This solder element array may produce a more reliable electrical ground for various integrated circuits and other components in an input device. As such, in one or more embodiments, the solder element array produces an electrical path with a low resistance for electrostatic discharge events to the bracket component. In particular, this electrical path may have a lower resistance than another electrical path towards one or more integrated circuits mounted in a sensor substrate, and thus may protect the one or more integrated circuits from damage by the electrostatic discharge event.

While Step 540 is described as a separate step from Step 530 and Step 520, in one or more embodiments, one or more steps among Steps 520-540 may be combined. For example, the sensor substrate may be coupled to the bracket using the solder paste array in Step 520 and heated during a reflow process.

In Step 550, a sensor substrate is mounted in an input device in accordance with one or more embodiments. In particular, after various reflow and/or SMT processes are performed on the sensor substrate from Step 500, the sensor substrate is installed in an input device similar to the one described in FIG. 1 and the accompanying description. For example, the contact area from Step 510 may have protective coating residue remaining after the protective coating is removed in Step 530. This protective coating residue may be an organic solderability preservative compound, or a product resulting from the use of an organic solderability preservative compound during the manufacturing process. Moreover, the solder paste array from Step 520 may be transformed into a solder element array, for example, by a heating process in Step 530.

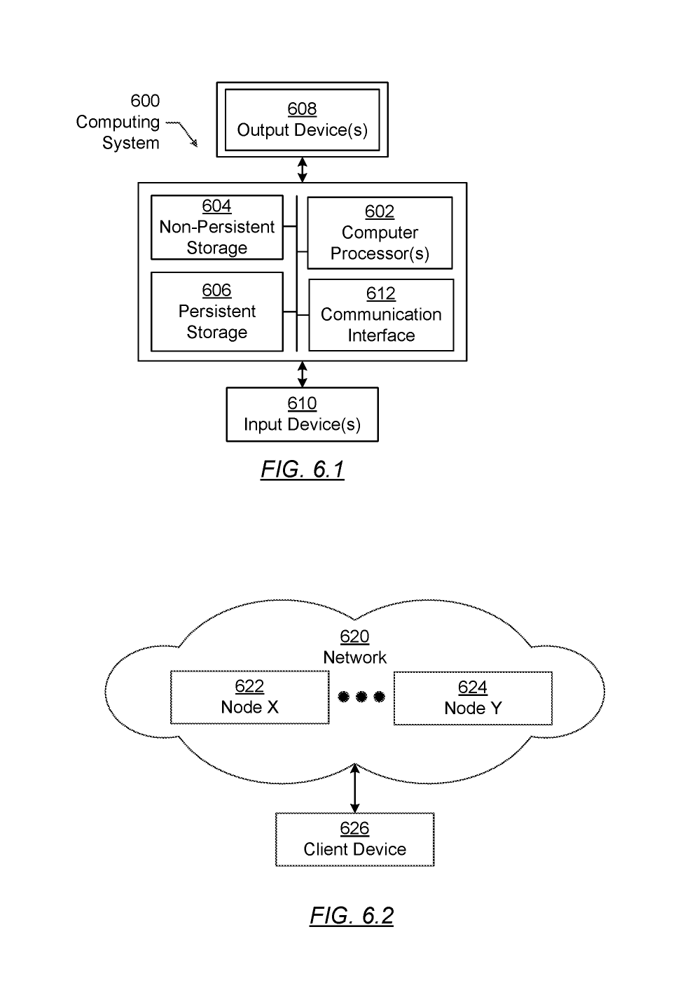

In Step 560, an input device is mounted in an electronic system in accordance with one or more embodiments. The electronic system may be similar to the computing system described below in FIGS. 6.1 and 6.2 and the accompanying description. Accordingly, the input device from Step 550 may be operably coupled to a processing system and/or a display device. Furthermore, the bracket component from Step 540 may be coupled to a chassis of a laptop computer, for example.

Embodiments of the invention may be implemented on a computing system. Any combination of mobile, desktop, server, router, switch, embedded device, or other types of hardware may be used. For example, as shown in FIG. 6.1, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities.

The computer processor(s) (602) may be an integrated circuit for processing instructions. For example, the computer processor(s) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (600) in FIG. 6.1 may be connected to or be a part of a network. For example, as shown in FIG. 6.2, the network (620) may include multiple nodes (e.g., node X (622), node Y (624)). Each node may correspond to a computing system, such as the computing system shown in FIG. 6.1, or a group of nodes combined may correspond to the computing system shown in FIG. 6.1. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (600) may be located at a remote location and connected to the other elements over a network.

Although not shown in FIG. 6.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6.1. Further, the client device (626) may include and/or perform all or a portion of one or more embodiments of the invention.

The computing system or group of computing systems described in FIGS. 6.1 and 6.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system (600) in FIG. 6.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 6.1, while performing one or more embodiments of the invention, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 6.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 6.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present only a few examples of functions performed by the computing system of FIG. 6.1 and the nodes and/or client device in FIG. 6.2. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of manufacturing, comprising:
obtaining a contact area covered in a protective coating configured to prevent oxidation of the contact area, wherein the contact area is coupled to a sensor substrate comprising a plurality of sensor electrodes configured to detect a location of one or more input objects;
depositing a solder paste array on the contact area;
removing a portion of the protective coating from the contact area; and
coupling the contact area to a bracket component.

2. The method of claim 1, wherein the protective coating comprises an organic solderability preservative (OSP) compound.

3. The method of claim 1, further comprising:
coupling, using a surface mount technology (SMT) process, an integrated circuit to the sensor substrate,
wherein the portion of the protective coating is removed before using the SMT process.

4. The method of claim 1, further comprising:
coupling the bracket component to an electrical ground in an input device.

5. The method of claim 4,
wherein the input device comprises an integrated circuit,
wherein the integrated circuit is ohmically coupled to the contact area using a plurality of routing traces, and
wherein the contact area is configured to provide, for an electrostatic discharge event, a first electrical path with a lower impedance to the electrical ground than a second electrical path towards the integrated circuit.

6. The method of claim 1,
wherein the solder paste array produces, using a heating process, a plurality of solder elements connecting the bracket component with the contact area, and
wherein the plurality of solder elements cause an electrical ground pin of an integrated circuit to have approximately the same electric potential as the bracket component.

7. The method of claim 1,
wherein the solder paste array comprises a plurality of solder balls arranged in the contact area in a predetermined pattern, and
wherein the plurality of solder balls in the predetermined pattern have a predetermined pitch separating adjacent solder balls among the plurality of solder balls.

8. The method of claim 1, further comprising:
mounting an input device within an electronic system,
wherein the input device comprises the sensor substrate and the bracket component.

9. The method of claim 1,
wherein removing the portion of the protective coating comprises heating the sensor substrate until the portion of the protective coating evaporates from the sensor substrate.

10. An input device, comprising:
a sensor substrate comprising a plurality of sensor electrodes configured to detect a location of one or more input objects;
a contact area coupled with the sensor substrate, the contact area comprising a protective coating residue and a solder element array disposed on the contact area; and
an electrical ground ohmically coupled to the contact area through the solder element array.

11. The input device of claim 10,
wherein the protective coating residue comprises an organic solderability preservative (OSP) compound.

12. The input device of claim 10,
wherein the solder element array is produced by heating a solder paste array in the contact area.

13. The input device of claim 10, further comprising:
a bracket component coupled to the contact area through the solder element array,
wherein the bracket component is ohmically coupled to the electrical ground.

14. The input device of claim 10, further comprising:
an integrated circuit ohmically coupled to the contact area using a plurality of routing traces,
wherein the contact area is configured to provide, for an electrostatic discharge event, a first electrical path with a lower resistance to the electrical ground than a second electrical path towards the integrated circuit.

15. The input device of claim 10, further comprising:
an integrated circuit ohmically coupled to the contact area using a plurality of routing traces,
wherein the solder element array causes an electrical ground pin of the integrated circuit to have approximately the same electric potential as a bracket component coupled to the contact area.

16. The input device of claim 10,
wherein the protective coating residue is a result of heating the sensor substrate until a portion of a protective coating covering the contact area evaporated from the sensor substrate, and
wherein the protective coating is configured to prevent oxidation of the contact area.

17. The input device of claim 10,
wherein the solder element array comprises a plurality of solder balls arranged in the contact area in a predetermined pattern, and
wherein the plurality of solder balls in the predetermined pattern have a predetermined pitch separating adjacent solder balls among the plurality of solder balls.

18. An electronic system, comprising:
a display device; and
an input device coupled to the display device, the input device comprising:
a sensor substrate comprising a plurality of sensor electrodes configured to detect a location of one or more input objects;
a contact area coupled with the sensor substrate, the contact area comprising a protective coating residue and a solder element array disposed on the contact area; and
an electrical ground ohmically coupled to the contact area through the solder element array.

19. The electronic system of claim 18, wherein the input device further comprises:
an integrated circuit ohmically coupled to the contact area using a plurality of routing traces,
wherein the contact area is configured to provide, for an electrostatic discharge event, a first electrical path with a lower resistance to the electrical ground than a second electrical path towards the integrated circuit.

20. The electronic system of claim 18, wherein the input device further comprises:
an integrated circuit ohmically coupled to the contact area using a plurality of routing traces,
wherein the solder element array causes an electrical ground pin of the integrated circuit to have approximately the same electric potential as a bracket component coupled to the contact area.
